(19) United States
(12) Patent Application Publication
(10) Pub. No.: US 2025/0161915 A1
(43) Pub. Date: May 22, 2025

(54) MESO-ALUMINA AND METHODS OF PREPARING

(71) Applicant: Saudi Arabian Oil Company, Dhahran (SA)

(72) Inventors: Mohammad Z. Al-Bahhar, Dhahran (SA); Lianhui Ding, Dhahran (SA); Rawan S. Alawami, Dhahran (SA); Mohammad F. Aljishi, Dhahran (SA)

(21) Appl. No.: 18/514,492

(22) Filed: Nov. 20, 2023

(51) Int. Cl. B01J 21/04; B01J 35/10; B01J 37/00; B01J 37/03; B01J 37/08

(52) U.S. Cl. CPC B01J 21/04; B01J 35/617; B01J 35/638; B01J 35/647; B01J 37/0018; B01J 37/031; B01J 37/08

(57) ABSTRACT

This disclosure relates to a meso-alumina catalyst with high surface area and pore volume. This disclosure also relates to a method of preparing a meso-alumina catalyst with high surface area and pore volume.

### TECHNICAL FIELD

This document relates to a meso-alumina catalyst with high surface area and pore volume. This document also relates to a method of preparing a meso-alumina catalyst with high surface area and pore volume.

### BACKGROUND

Alumina is widely used and an important catalyst support for petroleum processing. Alumina can be used in petroleum processing such as hydrotreating, hydrocracking, reforming, and fluid catalytic cracking (FCC). Alumina can also be used in petrochemicals production. There are many different phases of natural and synthesized alumina; however, only gamma and eta-alumina are active in catalytic reactions. The catalytic activity of gamma alumina is due to the high surface area and good porosity. The high surface area and good porosity favors good dispersion of the metal, and leads to enough strength after formulation to be a catalyst. Compared with conventional alumina, mesoporous alumina (MA) has excellent properties such as highly uniform channels, large surface area, nanoscale dimensions, and narrow pore size distribution. The high surface area and nanoscale dimensions of MA enhance the density of active sites on the surface of catalysts. Moreover, compared to conventional alumina, both basic sites for MA support are improved, resulting in higher catalytic activity. MA support also can preserve active metal particles contained inside the pore channels, inhibiting the occurrence of sintering and metal particle deactivation. Thus, MA has shown promising attributes as a catalyst support.

Previously reported synthesis routes of MA in the literature include hydrolysis, sol-gel, hydrothermal, and evaporation self-induced assembly (EISA). Typically the hydrolysis route only involves an aluminum precursor and a structure-directing agent (SDA). Zhang et al. synthesized large MA via a hydrolysis method of aluminum tri-sec-butoxide in an oil-in-water microemulsion along with cetyltrimethylammonium bromide (CTAB) as a SDA. See Zhang et al. “The synthesis of large mesopores alumina by microemulsion templating, their characterization and properties as catalyst support” Mater Lett 2004, 58, pages 2872-2877. The sol-gel approach is typically based on the utilization of aluminum hydrate and a soft template as an SDA. MA can retain the shape and structure of the source material after removing the SDA and the surface hydroxyl groups through a heating process. The conventional calcination treatment at high temperature for increasing crystallinity can cause the collapse of the mesoporous structure and loss of surface area resulting in decreased catalytic activity. Thus, the hydrothermal approach is preferable and widely used for improving a mesoporous materials' crystallinity, surface area, and thermal stability at elevated temperatures and pressures. Liu et al. demonstrated the hydrothermal technique for synthesizing MA using aluminum nitrate nonahydrate as a precursor, ammonia (NH₃) as a pre-neutralization agent, urea, and CTAB as the surfactant. See Liu et al. “Morphologically controlled synthesis of mesoporous alumina” Microporous Mesoporous Mater 2007; 100, pages 35-44. The synthesized MA had a high surface area of 331.0 m²/g, broad pore distribution of 3.7 nm, and small pore volume of 0.25 ml/g. The EISA approach employs organic solvents like propanol, ethanol, etc. as a reaction medium together with the aluminum precursor, block copolymer template, and acid solution, which is almost like a nonaqueous sol-gel technique.

Therefore, there is a need for a method of preparing a meso-alumina catalyst with increased surface area of at least 400 m²/g and increased pore volume of at least 1.5 ml/g.

### SUMMARY

Provided in the present disclosure is a process of preparing a meso-alumina catalyst, the process including: preparing a first solution using AlCl₃ and a first solvent; adjusting the pH of the first solution; preparing a second solution using the precipitate and a second solvent; peptizing the precipitate in the second solvent using an acid; reacting the peptized precipitate with a structure-directing agent; and calcining the resulting product of the peptized precipitate and the structure-directing agent resulting in the meso-alumina catalyst.

In some embodiments, the meso-alumina catalyst has a surface area of at least 400 m²/g.

In some embodiments, the meso-alumina catalyst has a pore volume of at least 1.5 ml/g.

In some embodiments, the meso-alumina catalyst has pore sizes of at least about 15 nm

In some embodiments, the first solvent comprises water.

In some embodiments, the water to aluminum molar ratio is about 3000 to about 8000.

In some embodiments, the second solvent comprises water.

In some embodiments, the adjusting the pH of the first solution includes the addition of ammonia to the first solution.

In some embodiments, the ammonia to aluminum molar ratio is about 3 to about 5.

In some embodiments, the adjusting the pH of the first solution includes the dropwise addition of ammonia to the first solution.

In some embodiments, the adjusting the pH of the first solution comprises the dropwise addition of ammonia to the first solution.

In some embodiments, the adjusting the pH of the first solution comprises adjusting the pH to greater than about 3, about 3.5, about 4, or about 4.5.

In some embodiments, the adjusting the pH of the first solution comprises adjusting the pH to greater than about 3.8.

In some embodiments, collecting the precipitate from the first solution comprises adding a third solution of ammonia to the first solution to form the precipitate.

In some embodiments, the acid comprises HNO₃.

In some embodiments, the structure-directing agent is F-127.

In some embodiments, the process further includes drying the resulting product of the peptized precipitate and the structure-directing agent.

In some embodiments, wherein drying comprises drying the resulting product at 70-120° C. overnight.

In some embodiments, wherein calcining the resulting product includes heating the resulting product to about 400 to about 700° C.

In some embodiments, wherein the heating the resulting product includes heating for about 2 to about 6 hours increasing the temperature about 2° C. per minute.

In some embodiments, the structure-directing agent to aluminum molar ratio is about 0.2 to about 2.

In some embodiments, the acid to aluminum molar ratio is about 5 to about 30.

### DESCRIPTION OF DRAWINGS

FIG. 1 illustrates the pore size distributions of three reference samples versus an embodiment of the current disclosure.

FIG. 2 illustrates the XRD profiles for four reference samples versus an embodiment of the current disclosure after the calcination.

### DETAILED DESCRIPTION

There is a need for a method of preparing a meso-alumina catalyst with high surface area and high pore volume. The increased surface area provides more reaction sites. Increased pore volume assists large molecule diffusion inside the catalysts. A meso-alumina catalyst prepared as described herein may have a narrower pore size distribution. A meso-alumina catalyst helps improve catalyst stability and efficiency.

In some embodiments, the meso-alumina catalyst described herein is used in the production of ultra-low-sulfur diesel (ULSD). In some embodiments, the meso-alumina catalyst described herein is used for hydrocracking/fluid catalytic cracking (FCC) pretreatment catalysts to improve the catalyst activity in hydrodesulfurization (HDS), hydrodenitrogenation (HDN), and/or aromatic saturation. In some embodiments, the meso-alumina catalyst described herein provides improved catalytic life time. In some embodiments, the meso-alumina catalyst described herein provides refinery benefits due to increased product yields, improved product quality, and/or longer catalytic service time. In some embodiments, the meso-alumina catalyst described herein are useful for many refining/petrochemical catalysts such as FCC, hydrocracking, and reforming catalysts.

In some embodiments, a process of preparing a meso-alumina catalyst results in a meso-alumina with high surface area and high pore volume. The process may include preparing a first solution using AlCl₃ and a first solvent. The process may include adjusting the pH of the first solution. The process may include collecting a precipitate from the first solution. A second solution may be prepared using the precipitate and a second solvent. The precipitate may be peptized in the second solvent using an acid. The peptized precipitate may be reacted with a structure-directing agent. The resulting product of the peptized precipitate and the structure-directing agent is calcined resulting in the meso-alumina catalyst.

The processes described herein result in a meso-alumina catalyst with a high surface area. In some embodiments, the meso-alumina catalyst has a surface area of at least 400 m²/g. In some embodiments, the meso-alumina catalyst has a surface area of at least about 400 m²/g. In some embodiments, the meso-alumina catalyst has a surface area of at least 500 m²/g. In some embodiments, the meso-alumina catalyst has a surface area of at least 600 m²/g.

The processes described herein result in a meso-alumina catalyst with a high pore volume. In some embodiments, the meso-alumina catalyst has a pore volume of at least 1.5 ml/g. In some embodiments, the meso-alumina catalyst has a pore volume of at least about 1.5 ml/g. In some embodiments, the meso-alumina catalyst has a pore volume of at least about 1.8 ml/g. In some embodiments, the meso-alumina catalyst has a pore volume of at least about 2.0 ml/g.

The processes described herein result in a meso-alumina catalyst with a large pore size. In some embodiments, the meso-alumina catalyst has pore sizes of at least about 15 nm. In some embodiments, the meso-alumina catalyst has an average pore size of about 40 nm. In some embodiments, the meso-alumina catalyst has an average pore size of about 30 nm to about 50 nm. Narrow pore size distributions can increase a catalysts activity as well as provide greater predictability.

The process may include preparing a first solution using AlCl₃ and a first solvent. Aluminum chloride may be used as a source of aluminum for the preparing the meso-alumina catalyst. Aluminum chloride, also known as aluminum trichloride, is an inorganic compound with the formula AlCl₃. Aluminum chloride typically forms a hexahydrate with the formula [Al(H₂O)₆]Cl₃, containing six water molecules of hydration. Both the anhydrous form and the hexahydrate are colorless crystals, but samples are often contaminated with iron (III) chloride, giving them a yellow color.

The anhydrous form of aluminum chloride is important commercially. Aluminum chloride has a low melting point and a boiling point. Aluminum chloride is mainly produced and consumed in the production of aluminum metal, but large amounts are also used in other areas of the chemical industry. The compound is often cited as a Lewis acid. Aluminum chloride is an example of an inorganic compound that reversibly changes from a polymer to a monomer at mild temperature.

The process may include preparing a first solution using AlCl₃ and a first solvent. In some embodiments, the first solvent includes water. In some embodiments, the water to aluminum molar ratio is about 3000 to about 8000. In some embodiments, the water to aluminum molar ratio is about 4000 to about 7000. In some embodiments, the water to aluminum molar ratio is about 5000 to about 6000.

The process may include adjusting the pH of the first solution. In some embodiments, adjusting the pH of the first solution comprises the addition of ammonia to the first solution. The ammonia solution is about 5% to about 20% ammonia. In some embodiments, the addition of ammonia is effected by slow (e.g., dropwise) addition of the ammonia. The pH of the first solution may be adjusted to greater than about 3, about 3.5, about 4, or about 4.5. In some embodiment, the pH of the first solution may be adjusted to a pH of greater than 3.8. In some embodiment, the pH of the first solution may be adjusted to a pH of greater than about 3.8. In some embodiments, the ammonia to aluminum molar ratio is about 3 to about 5.

In some embodiments, a precipitate is formed from the first solution. The precipitate may be formed after adjustment of the pH (e.g., by the addition of the ammonia solution). The process may include collecting a precipitate from the first solution. The precipitate may be formed by the quick addition of an ammonia solution. The ammonia solution may be the same solution that is added dropwise to the first solution. The ammonia solution is about 5% to about 20% ammonia. The precipitate may be white.

The process may include collecting the precipitate. Collection of the precipitate may include substantially separating the precipitate from the first solution. Collection may include standard procedures for collecting precipitates including filtration, vacuum assisted filtration, or distillation. Collection of the precipitate may be accomplished by centrifuge. The collected precipitate may be washed. The precipitate may be washed. The precipitate may be washed multiple times (e.g., 3 times). The precipitate may be washed with water.

A second solution may be prepared using the precipitate and a second solvent. In some embodiments, the precipitate is dispersed in a second solvent. The second solvent may be water.

The precipitate may be peptized in the second solvent using an acid. In some embodiments, the acid is an organic acid or an inorganic acid. In some embodiments the acid is nitric acid (HNO₃). Nitric acid may include benefits due to no anions remaining after calcination. In some embodiments, the acid is sulfuric acid. In some embodiments, the acid is hydrochloric acid. In some embodiments, the acid is citric acid, salicylic acid, or phthalic acid. The acid may be about 0.5 to about 2 M concentration. In some embodiments, the acid to aluminum molar ratio is about 5 to about 30. The precipitate may be peptized under elevated temperatures. The temperature of the reaction may be about 50° C. to about 90° C. The reaction may be stirred or agitated in some fashion. The reaction may be stirred for about 2 to about 6 hours. In some embodiments, the reaction is run until a stable boehmite sol is achieved.

The peptized precipitate may be reacted with a structure-directing agent. In some embodiments, the structure-directing agent is added to second solvent with the peptized precipitate. In some embodiments, the structure directing agent is a hydrophilic non-ionic surfactant. In some embodiments, the structure directing agent is F-127. In some embodiments, the structure directing agent is selected from P123, CTAB, Pluronic 64L, tergitol 15-S-9, Triton X-114, 1-hexadecyl-2,3-dimethyl-imidazolium chloride, or Polyglycol. The structure-directing agent to aluminum molar ratio is about 0.2 to about 2. The reaction may be stirred and/or agitated in some form a length of time. The reaction may be stirred and/or agitated in some form for about 10 to about 20 hours. The reaction may be stirred and/or agitated in some form for about 2 to 15 about 40 hours. The reaction may be run at room temperature.

The resulting product of the reaction of the peptized precipitate and the structure-directing agent may be dried. The resulting product may be dried at an elevated temperature. The elevated temperature may be about 70° C. to about 120° C. The resulting product may be dried overnight.

The resulting product of the peptized precipitate and the structure-directing agent is calcined resulting in the meso-alumina catalyst. In some embodiments, the resulting product is calcined at an elevated temperature of about 400° C. to about 700° C. In some embodiments, the resulting product is calcined at an elevated temperature of about 200° C. to about 900° C. Heating the resulting product may include heating for about 2 to about 6 hours. The temperature may be increased at a controlled rate. The temperature may be increased about 2° C. per minute.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

“Calcination”, as used herein, refers to a process of heating a substance to a high temperature but typically below the melting or fusing point, causing loss of moisture, reduction or oxidation, and/or dissociation into simpler substances.

“Peptize”, as used herein, is generally defined as dispersing a substance or precipitate in a liquid medium to form a colloid.

“Structure-directing agent”, as used herein, refers to chemicals which help in the formation of particular channels and pores during the synthesis of, for example, zeolites. Zeolites have varied applications including as catalysts and adsorbents.

### EXAMPLES

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results. Four reference MAs (MesoAl-49, 50, 51, 53) were produced based on known methods are detailed below to compare with MAs (MesoAl-56) produced using embodiments described herein.

### Example 1: MesoAl-49 Synthesis (Reference)

1. 7.5 g of Al(NO₃)3·9H₂O was dissolved in 40 ml H₂O.
2. 2.5% ammonia was dropwise added into the solution until pH>3.8. 25 ml of ammonia was poured into the solution and a white precipitation was formed immediately.
3. Separate by centrifuge, washed 3 times, and dispersed in 30 ml H₂O, and peptized with 7.33 g of 1M HNO₃ at 80° C. under vigorous stirring for 4 h to obtain a stable boehmite sol.
4. 6.96 g of P123 was added. Stir for another 12 h at RT. T
5. The above mixture was dried at 70° C. overnight.
6. 600° C. calcination for 4 h (ramp 2° C./min).

### Example 2: MesoAl-50 Synthesis (Reference)

1. 13.33 g of Al₂(SO₄)₃·18H₂O was dissolved in 40 ml H₂O.
2. 2.5% ammonia was dropwise added into the solution until pH>3.8. 25 ml of ammonia was poured into the solution and a white precipitation was formed immediately.
3. Separate by centrifuge, washed 3 times, and dispersed in 30 ml H₂O, and peptized with 7.33 g of 1M HNO₃ at 80° C. under vigorous stirring for 4 h to obtain a stable boehmite sol.
4. 6.96 g of P123 was added. Stir for another 12 h at RT
5. The above mixture was dried at 70° C. overnight.
6. 600° C. calcination for 4 h (ramp 2° C./min).

### Example 3: MesoAl-51 Synthesis (Reference)

1. 4.83 g of AlCl₃·6H₂O was dissolved in 40 ml H₂O.
2. 2.5% ammonia was dropwise added into the solution until pH>3.8. 25 ml of ammonia was poured into the solution and a white precipitation was formed immediately.
3. Separate by centrifuge, washed 3 times, and dispersed in 30 ml H₂O, and peptized with 7.33 g of 1M HNO₃ at 80° C. under vigorous stirring for 4 h to obtain a stable boehmite sol.
4. 6.96 g of P123 was added. Stir for another 12 h at RT
5. The above mixture was dried at 70° C. overnight.
6. 600° C. calcination for 4 h (ramp 2° C./min).

### Example 4: MesoAl-53 Synthesis (Reference)

1. 7.5 g of Al(NO₃)₃·9H₂O was dissolved in 40 ml H₂O.
2. (5 ml) 10% ammonia was dropwise added into the solution until pH>3.8. 60 ml of 2.5% ammonia was poured into the solution and a white precipitation was formed immediately.
3. Separate by centrifuge, washed 3 times, and dispersed in 30 ml H₂O, and peptized with 7.33 g of 1M HNO₃ at 80° C. under vigorous stirring for 4 h to obtain a stable boehmite sol.
4. 14.39 of F-127 was added. Stir for another 12 h at RT
5. The above mixture was dried at 70° C. overnight.
6. 600° C. calcination for 4 h (ramp 2° C./min).

### Example 5: MesoAl-56 Synthesis (Disclosed Method)

1. 4.83 g of AlCl₃·6H₂O was dissolved in 40 ml H₂O.
2. (5 ml) 10% ammonia was dropwise added into the solution until pH>3.8. 60 ml of 10% ammonia was poured into the solution and a white precipitation was formed immediately.
3. Separate by centrifuge, washed 3 times, and dispersed in 30 ml H₂O, and peptized with 7.33 g of 1M HNO₃ at 80° C. under vigorous stirring for 4 h to obtain a stable boehmite sol.
4. 15 g of F-127 was added. Stir for another 12 h at RT
5. The above mixture was dried at 70° C. overnight.
6. 600° C. calcination for 4 h (ramp 2° C./min).

The molar ratio of chemicals in the synthesis gel, the synthesis conditions, and the textural properties of the five samples are summarized in the table below. The results show that, compared with the reference MA using other inorganic aluminum sources and different SDA (i.e., P123 and F127), the samples prepared using the disclosed processes have much higher surface area and pore volume.

TABLE 1

| | | | | | MesoAl- |
|---|---|---|---|---|---|
| | MesoAl- | MesoAl- | MesoAl- | MesoAl- | 56 |
| Sample | 49 | 50 | 51 | 53 | Current |
| Name | Reference | Reference | Reference | Reference | process |
| Al source | Al(NO₃)₃ | Al₂(SO₄)₃ | AlCl₃ | Al(NO₃)₃ | AlCl₃ |
| Template | P123 | P123 | P123 | F127 | F127 |
| Other | HNO₃ | HNO₃ | HNO₃ | HNO₃ | HNO₃ |
| Molar ratio | | | | | |
| in synthesis | | | | | |
| gel | | | | | |
| Al source, | 1 | 1 | 1 | 1 | 1 |
| mol | | | | | |
| Template/Al | 3 | 3 | 3 | 3 | 3 |
| H₂O/Al | 5000 | 5000 | 5000 | 5000 | 5000 |
| HNO₃/Al | 17.5 | 17.5 | 17.5 | 17.5 | 17.5 |
| ratio | | | | | |
| Conditions | | | | | |
| Aging T, | RT | RT | RT | RT | RT |
| ° C. | | | | | |
| Time, h | 12 | 12 | 12 | 12 | 12 |
| Drying T, | 70 | 70 | 70 | 70 | 70 |
| ° C. | | | | | |
| Time, h | 12 | 12 | 12 | 12 | 12 |
| Calcination | 600 | 600 | 600 | 600 | 600 |
| T, ° C. | | | | | |
| Time, h | 4 | 4 | 4 | 4 | 4 |
| BET result | | | | | |
| Surface area, | 279 | 87 | 288 | 347 | 598 |
| m²/g | | | | | |
| Micro | 0 | 26 | 3 | 7 | 0 |
| Meso | 279 | 61 | 285 | 340 | 598 |
| Pore volume, | 1.74 | 0.26 | 2.18 | 1.45 | 2.89 |
| ml/g | | | | | |
| Micro | 0.00 | 0.01 | 0.00 | 0.01 | 0 |
| Meso | 1.74 | 0.25 | 2.18 | 1.45 | 2.89 |
| Average | 24.89 | 12.05 | 30.34 | 16.75 | 19.36 |
| pore size, | | | | | |
| nm | | | | | |

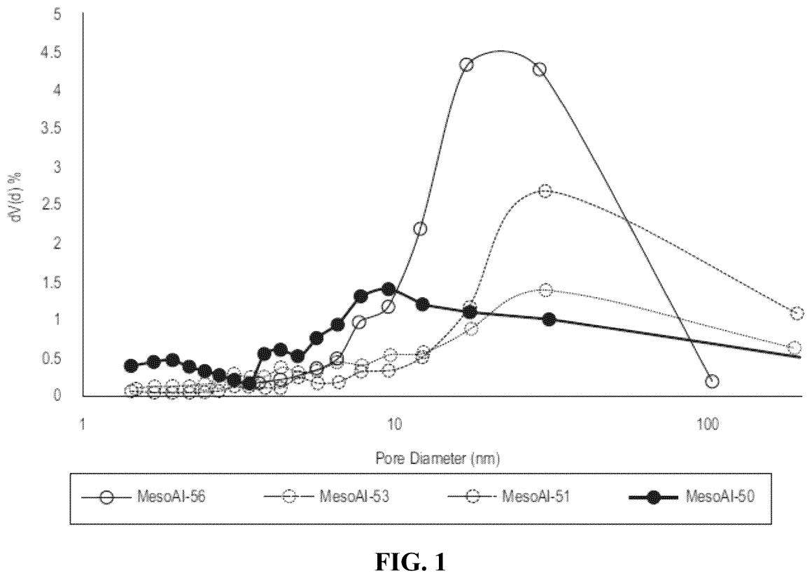

FIG. 1 illustrates the pore size distributions of three reference samples versus an embodiment of the current disclosure. Compared with other reference samples, the sample MesoAl-56 prepared by the disclosed processes has a much narrow pore size distribution (centered at about 20 nm). For other reference samples, the pore size distribution is far greater.

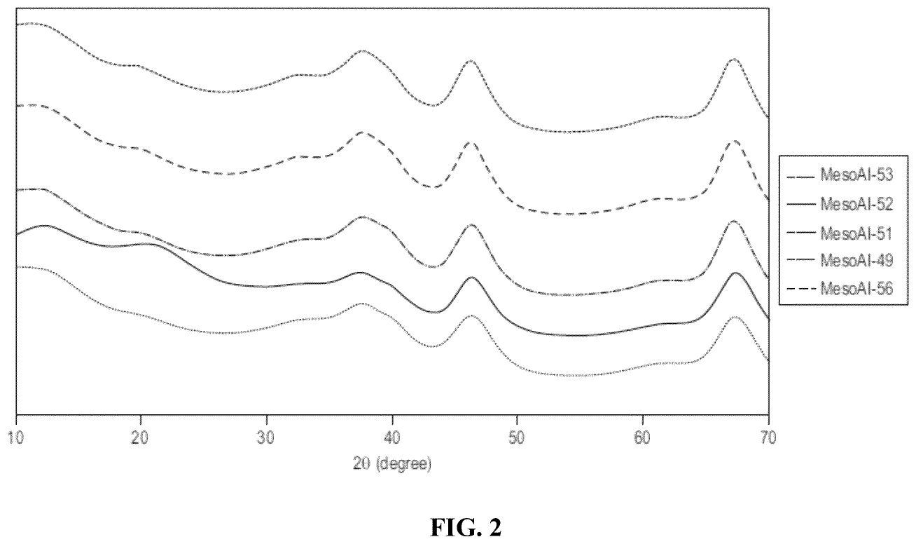

FIG. 2 illustrates the XRD profiles for four reference samples versus an embodiment of the current disclosure after the calcination. The XRD profiles indicate that all samples are converted to well crystallized gamma alumina. The gamma alumina is the active phase for hydrocracking, hydrotreating, FCC, and reforming catalysts. The new combination of the disclosed aluminum source and SDA (F127) leads to unexpected high surface area and pore volume, and narrowed pore size distribution. Meso-alumina with high surface area and pore volume is synthesized with inorganic AlCl₃ as an Al source and F-127 as structure directing agent, and a new process method. The pore volume and surface area of the alumina prepared with the disclosed process increase by 40% and 15% respectively compared with commercialized alumina. The improved MA provides more active sites and thus improves the refinery processing catalyst reaction performance.

### Embodiments

An embodiment is provided of a process of preparing a meso-alumina catalyst, the process comprising: preparing a first solution using AlCl₃ and a first solvent; adjusting the pH of the first solution; preparing a second solution using the precipitate and a second solvent; peptizing the precipitate in the second solvent using an acid; reacting the peptized precipitate with a structure-directing agent; and calcining the resulting product of the peptized precipitate and the structure-directing agent resulting in the meso-alumina catalyst.

The process of the above embodiment, wherein the meso-alumina catalyst has a surface area of at least 400 m²/g.

The process of any of the above embodiments, wherein the meso-alumina catalyst has a pore volume of at least 1.5 ml/g.

The process of any of the above embodiments, wherein the meso-alumina catalyst has pore sizes of at least about 15 nm.

The process of any of the above embodiments, wherein the first solvent comprises water.

The process of any of the above embodiments, wherein the water to aluminum molar ratio is about 3000 to about 8000.

The process of any of the above embodiments, wherein the second solvent comprises water.

The process of any of the above embodiments, wherein the adjusting the pH of the first solution comprises the addition of ammonia to the first solution.

The process of any of the above embodiments, wherein the ammonia to aluminum molar ratio is about 3 to about 5.

The process of any of the above embodiments, wherein the adjusting the pH of the first solution comprises the dropwise addition of ammonia to the first solution.

The process of any of the above embodiments, wherein the adjusting the pH of the first solution comprises adjusting the pH to greater than about 3, about 3.5, about 4, or about 4.5.

The process of any of the above embodiments, wherein the adjusting the pH of the first solution comprises adjusting the pH to greater than about 3.8.

The process of any of the above embodiments, further comprising collecting the precipitate from the first solution, wherein collecting the precipitate from the first solution comprises adding a third solution of ammonia to the first solution to form the precipitate.

The process of any of the above embodiments, wherein the acid comprises HNO₃.

The process of any of the above embodiments, wherein the structure-directing agent comprises F-127.

The process of any of the above embodiments, further comprising drying the resulting product of the peptized precipitate and the structure-directing agent.

The process of the above embodiment, wherein drying comprises drying the resulting product at about 70 to about 120° C. overnight.

The process of any of the above embodiments, wherein calcining the resulting product comprising heating the resulting product to about 400° C. to about 700° C.

The process of any of the above embodiments, wherein the heating the resulting product comprises heating for about 2 to about 6 hours increasing the temperature about 2° C. per minute.

The process of any of the above embodiments, wherein the structure-directing agent to aluminum molar ratio is about 0.2 to about 2.

The process of any of the above embodiments, wherein the acid to aluminum molar ratio is about 5 to about 30.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A process of preparing a meso-alumina catalyst, the process comprising:
preparing a first solution using AlCl₃ and a first solvent;
adjusting the pH of the first solution to form a precipitate;
preparing a second solution using the precipitate and a second solvent;
peptizing the precipitate in the second solvent using an acid;
reacting the peptized precipitate with a structure-directing agent; and
calcining the resulting product of the peptized precipitate and the structure-directing agent resulting in the meso-alumina catalyst.

2. The process of claim 1, wherein the meso-alumina catalyst has a surface area of at least 400 m²/g.

3. The process of claim 1, wherein the meso-alumina catalyst has a pore volume of at least 1.5 ml/g.

4. The process of claim 1, wherein the meso-alumina catalyst has pore sizes of at least about 15 nm.

5. The process of claim 1, wherein the first solvent comprises water.

6. The process of claim 1, wherein the water to aluminum molar ratio is about 3000 to about 8000.

7. The process of claim 1, wherein the second solvent comprises water.

8. The process of claim 1, wherein the adjusting the pH of the first solution comprises the addition of ammonia to the first solution.

9. The process of claim 1, wherein the ammonia to aluminum molar ratio is about 3 to about 5.

10. The process of claim 1, wherein the adjusting the pH of the first solution comprises the dropwise addition of ammonia to the first solution.

11. The process of claim 1, wherein the adjusting the pH of the first solution comprises adjusting the pH to greater than about 3, about 3.5, about 4, or about 4.5.

12. The process of claim 1, wherein the adjusting the pH of the first solution comprises adjusting the pH to greater than about 3.8.

13. The process of claim 1, further comprising collecting the precipitate from the first solution, wherein collecting the precipitate from the first solution comprises adding a third solution of ammonia to the first solution to form the precipitate.

14. The process of claim 1, wherein the acid comprises HNO₃.

15. The process of claim 1, wherein the structure-directing agent comprises F-127.

16. The process of claim 1, further comprising drying the resulting product of the peptized precipitate and the structure-directing agent.

17. The process of claim 13, wherein drying comprises drying the resulting product at about 70° C. to about 120° C. overnight.

18. The process of claim 1, wherein calcining the resulting product comprising heating the resulting product to about 400 to about 700° C.

19. The process of claim 1, wherein the heating the resulting product comprises heating for about 2 to about 6 hours increasing the temperature about 2° C. per minute.

20. The process of claim 1, wherein the structure-directing agent to aluminum molar ratio is about 0.2 to about 2.

21. The process of claim 1, wherein the acid to aluminum molar ratio is about 5 to about 30.
